(19) United States
(12) Patent Application Publication
(10) Pub. No.: US 2021/0372809 A1
(43) Pub. Date: Dec. 2, 2021

(54) TRAVEL ROUTE OBSERVATION AND COMPARISON SYSTEM FOR A VEHICLE

(71) Applicant: Toyota Motor Engineering & Manufacturing North America, Inc., Plano, TX (US)

(72) Inventor: Nathan T. Warner, Brighton, MI (US)

(21) Appl. No.: 16/890,023

(22) Filed: Jun. 2, 2020

(51) Int. Cl. G01C 21/36; G05D 1/02

(52) U.S. Cl. CPC G01C 21/367; G05D 1/0223; G01C 21/3676

(57) ABSTRACT

A travel route observation and comparison system for a vehicle includes one or more processors and a memory communicably coupled to the one or more processors. The memory stores a display control module including instructions that when executed by the one or more processors cause the one or more processors to control at least one display device to simultaneously display at least a first visual representation of at least a portion of a first travel route currently being traveled by the vehicle, and a second visual representation of the at least a portion of the first travel route during a previous traveling of the first travel route.

### TECHNICAL FIELD

The subject matter described herein relates in general to systems and methods for viewing vehicle travel routes and, more particularly, to a system and method enabling portions of a travel route currently being traveled by a vehicle, or being considered for travel, to be previewed prior to traveling the route.

### BACKGROUND

Owners of all-wheel drive and four-wheel drive vehicles may enjoy driving their vehicles on offroad routes or trails. However, some offroad routes may not be suitable for every vehicle, and some routes may have particular characteristics that would cause individual drivers to forego driving the route. Even if a driver decides to attempt driving a route without prior detailed information of the route, it may be difficult to gain detailed information on portions of an offroad route unless someone personally reconnoiters the route, which may be time-consuming, annoying, and/or impractical.

### SUMMARY

In one aspect of the embodiments described herein, a travel route observation and comparison system for a vehicle includes one or more processors and a memory communicably coupled to the one or more processors. The memory stores a display control module including instructions that when executed by the one or more processors cause the one or more processors to control at least one display device to simultaneously display at least a first visual representation of at least a portion of a first travel route currently being traveled by the vehicle, and a second visual representation of the at least a portion of the first travel route during a previous traveling of the first travel route.

In another aspect of the embodiments described herein, a method of controlling a display is provided. The method controls operation of the display to display images representing at least a first travel route which is currently being traveled by a vehicle. The method includes steps of displaying a first visual representation representing at least a portion of the at least a first travel route, and simultaneously displaying a second visual representation representing the at least a portion of the at least a first travel route during a previous traveling of the first travel route.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 is a schematic view of a display device illustrating a first visual representation of a travel route and a second visual representation of the travel route as vehicle-level views in a split-screen arrangement, in accordance with an embodiment described herein.

FIG. 2A is a schematic view of a display device similar to that shown in FIG. 2, with the second visual representation of the travel route including values of one or more vehicle operating parameters occurring at a location shown in the second visual representation.

FIG. 3 is a schematic view illustrating display of a first visual representation on a first display device and a second visual representation on a second display device different from the first display device.

FIG. 4A is a schematic view of display device showing a first visual representation and a second visual representation of a travel route, with the portion of the display device showing the first visual representation also including an inset usable for toggling to a digital graphical representation of the travel route.

FIG. 4B is a schematic view of the display device of FIG. 4A showing the first visual representation toggled from the vehicle-level view shown in FIG. 4A to a digital graphical representation of the travel route.

FIG. 5A is a schematic view showing simultaneous display of a first visual representation of a travel route, a second visual representation of the travel route, and a digital graphical representation of the travel route.

FIG. 5B is the schematic view of FIG. 5A illustrating movement of a cursor along the digital graphical representation of the travel route to advance view shown in the second visual representation of the travel route to a position farther along the travel route.

FIG. 6 is a schematic view of a display device showing simultaneous display of a first visual representation of a travel route, a second visual representation of the travel route from a first perspective, and a third visual representation of the travel route from a second perspective different from the first perspective.

FIG. 7A is a schematic view of a display device showing a first visual representation as a vehicle-level view of a first travel route and a second visual representation as a vehicle-level view of a second travel route, where the second travel route is different from the first travel route.

FIG. 7B is a schematic view of the display device shown in FIG. 7A displaying a digital graphical representation of the first travel route adjacent the vehicle-level view of the first travel route, and also displaying a digital graphical representation of the second travel route adjacent the vehicle-level view of the second travel route.

### DETAILED DESCRIPTION

A travel route observation and comparison system for a vehicle includes one or more processors and a memory communicably coupled to the one or more processors. The memory stores a display control module including instructions that when executed by the one or more processors cause the one or more processors to control at least one display device to simultaneously display at least a first visual representation of at least a portion of a first travel route currently being traveled by the vehicle, and a second visual representation of the at least a portion of the first travel route during a previous traveling of the first travel route. The first and second visual representations may be displayed adjacent each other on a split screen. The second visual representation may be in the form of streaming video, still photographs, or a digital graphical representation showing a track of the travel route. In some embodiments, the first and second visual representations may be displayed on different display devices. In some embodiments, a second travel route may be displayed in conjunction with the first travel route, to enable a comparison of the travel routes. In some embodiments, playback of streaming video in the second visual representation may be coordinated with a position on the route of a vehicle currently driving the route, so that the second visual representation always shows the portion of the route residing at the current navigational coordinates of the vehicle. In some embodiments, the second visual representation may show a portion of the travel route represented by the track in the digital graphical representation. The digital graphical representation may include a manipulatable cursor located at a point on the track corresponding to the location on the route shown in the second visual representation. The cursor may be dragged to a different location along the route track, and the view of the route shown in the second visual representation will correspondingly shift to reflect the portion of the route at the geographical coordinates corresponding to the new location of the cursor.

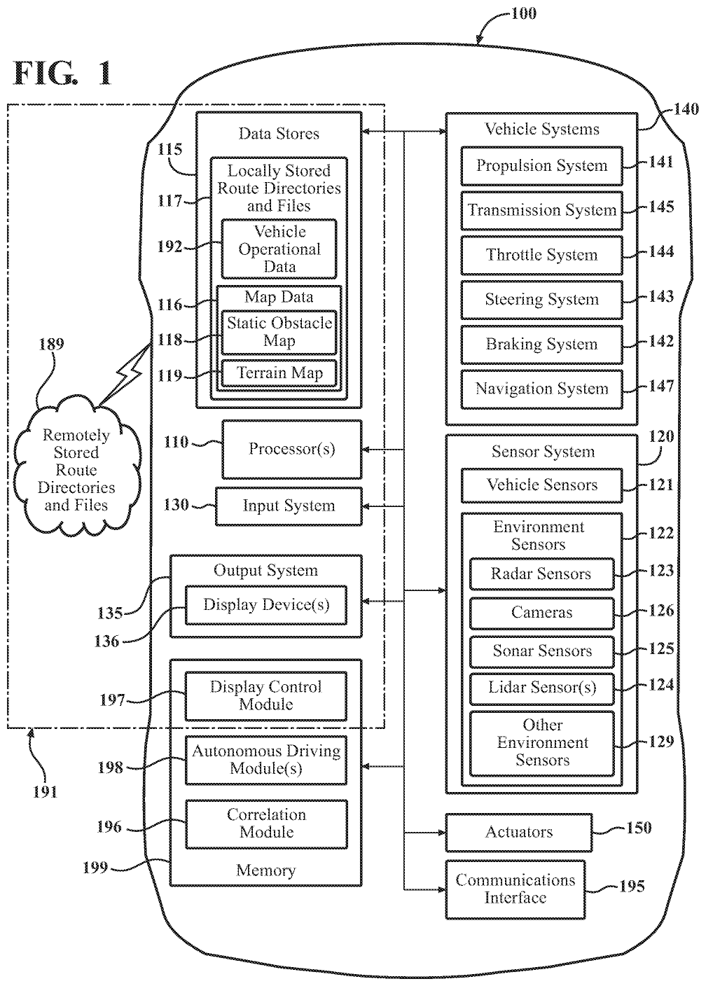

Referring to FIG. 1, an example of a vehicle 100 is illustrated. As used herein, a “vehicle” is any form of motorized transport. In one or more implementations, the vehicle 100 is a vehicle configured with all-wheel drive (AWD) and adapted for “offroading”. The activity of “offroading” or “offroad travel” refers to a vehicle traversing an offroad route or trail (i.e., a travel route involving movement “cross-country” or along an unpaved surface (especially a route involving rough terrain) on a ground surface). The offroad route may have been previously driven by the vehicle or by another vehicle. During a previous driving of the travel route, the vehicle driving the route may have used vehicle cameras and other sensors to acquire photographic and other information related to the route. This information may be stored, processed, and/or displayed as described herein to inform users of the route characteristics.

While arrangements will be described herein with respect to vehicles configured with all-wheel drive, it will be understood that embodiments are not limited to such vehicles. In some implementations, the vehicle 100 may be any other form of motorized transport that, for example, can operate at least semi-autonomously and includes an embodiment of a travel route observation and comparison system as described herein and capabilities to support such a system.

The vehicle 100 includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances.

Some of the possible elements of the vehicle 100 are shown in FIG. 1 and will be described along with subsequent figures. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

FIG. 1 will now be discussed in detail as an example vehicle environment within which the system and methods disclosed herein may operate. In some instances, the vehicle 100 is configured to switch selectively between an autonomous mode, one or more semi-autonomous operational modes, and/or a manual mode. Such switching (also referred to as handover when transitioning to a manual mode) can be implemented in a suitable manner, now known or later developed. “Manual mode” means that all of or a majority of the navigation and/or maneuvering of the vehicle is performed according to inputs received from a user (e.g., human driver/operator).

In one or more embodiments, the vehicle 100 is an autonomous vehicle. As used herein, “autonomous vehicle” refers to a vehicle that may operate in an autonomous mode. “Autonomous mode” refers to navigating and/or maneuvering the vehicle 100 along a travel route using one or more computing systems to control the vehicle 100 with minimal or no input from a human driver/operator. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along the travel route. Thus, in one or more embodiments, the vehicle 100 operates autonomously according to a particular defined level of autonomy. For example, the vehicle 100 can operate according to the Society of Automotive Engineers (SAE) automated vehicle classifications 0-5. In one embodiment, the vehicle 100 operates according to SAE level 2, which provides for the autonomous driving module 198 (described in greater detail below) controlling the vehicle 100 by braking, accelerating, and steering without operator input but the driver/operator is to monitor the driving and be vigilant and ready to intervene with controlling the vehicle 100 if the autonomous driving module 198 fails to properly respond or is otherwise unable to adequately control the vehicle 100.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, and/or a navigation system 147. Each of these systems can include one or more devices, components, and/or combination thereof, now known or later developed.

Embodiments of the vehicle 100 described herein incorporate (or are in operable communication with) a travel route observation and comparison system, generally designated 191 and shown enclosed in phantom in FIG. 1. The travel route observation and comparison system 191 may be implemented to perform methods and other functions as disclosed herein enabling a user to view characteristics of on-road and offroad travel routes that are currently being traveled by the vehicle 100, and/or one or more travel routes which have been traveled previously by a vehicle. The travel route observation and comparison system 191 is illustrated in FIG. 1 as integrated with the vehicle 100. However, in various embodiments the travel route observation and comparison system 191 may be configured as a sub-component of the vehicle 100 or may be separate from the vehicle 100. Thus, in one or more embodiments, the travel route observation and comparison system 191 can communicate via a wired or wireless connection with the vehicle 100 to provide functionality as discussed herein. The travel route observation and comparison system 191 may be configured to operate in coordination with the navigation system 147 and other vehicle systems, as required.

The vehicle 100 can include one or more processors 110. In one or more arrangements, the processor(s) 110 can be a main processor of the vehicle 100. For instance, the processor(s) 110 can be an electronic control unit (ECU).

The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operably connected to the processor(s) 110 for use thereby. The term “operably connected,” as used throughout this description, can include direct or indirect connections, including connections without direct physical contact. Data store(s) 115 may include buffers (not shown) for temporarily storing information downloaded from an entity remote from the vehicle (such as a cloud storage facility 189) and/or information to be transmitted to a remote entity for storage and/or processing.

Data store(s) 115 may store route directories and/or files (collectively designated 117) for playback under the control of the display control module 197 (described in greater detail below). A route directory may be a collection of all information relating to a particular travel route. Such information may include streaming video files, still photographs, files displayable as and/or supporting digital graphical representations of the travel route (which may be generated using available map data), sequences(s) of navigational coordinates describing the route, any available map data relating to a geographical area through which the travel route extends, and/or any other information describing and/or pertaining the travel route. Route directories and individual files relating to routes may be stored locally at a location in vehicle data store(s) 115. Alternatively, any route directories and/or individual files may be stored remotely (for example, in a cloud storage facility 189 or other facility) and may be accessed as needed using a vehicle wireless communications interface 195. The route directories and/or files may include geotagged files including correlated camera, navigational/geographical, and vehicle operational parameter information.

Route directory map data 116 can include maps of one or more geographic areas. In some instances, the map data 116 can include information or data on roads, traffic control devices, road markings, structures, features, and/or landmarks in the one or more geographic areas. The map data 116 may be stored on the vehicle or downloaded as needed from an off-vehicle source. The map data can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 119. The terrain map(s) 119 can include information about the ground, terrain, roads, surfaces, and/or other features of one or more geographic areas. The terrain map(s) 119 can include elevation data in the one or more geographic areas. The terrain map(s) 119 can be high quality and/or highly detailed. The terrain map(s) 119 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

In one or more arrangements, the vehicle operational data 192 may include vehicle sensor data acquired during traversal of travel routes by the vehicle. The data may be stored for later correlation or other processing or review.

The vehicle 100 can include a sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can function independently from each other. Alternatively, two or more of the sensors can work in combination with each other. In such a case, the two or more sensors can form a sensor network. The sensor system 120 and/or the one or more sensors can be operably connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., obstacles, terrain features, etc.).

The sensor system 120 can include any suitable type of sensor. Various examples of different types of sensors are described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Vehicle sensors 121 may include sensors for detecting or determining values of such vehicle operating parameters as engine RPM, throttle position, transmission gear currently engaged, transmission gear currently selected (which may differ from the gear currently engaged for automatic transmissions), engine coolant temperature, brake status and application level, and other parameters which may be affected by the characteristics of a travel route. Sensors may be included for measuring other vehicle operational parameters. Data gathered by vehicle sensors 121 may be geotagged to vehicle camera and navigational data by the correlation 196 as described herein, as the various types of data are acquired or at a later time. This associates vehicle responses to travel route characteristics with geographical locations and visual representations of the characteristics. Sensor data acquired during traveling of a route may be stored in vehicle operational data 192.

Alternatively, or in addition, the sensor system 120 can include one or more environment sensors 122 configured to acquire, and/or sense driving environment data. “Driving environment data” includes and data or information about the external environment in which the vehicle is located or one or more portions thereof. For example, the one or more environment sensors 122 can be configured to detect, quantify and/or sense characteristics of at least a portion of the external environment of the vehicle 100 and/or information/data about such characteristics. Such characteristics may include obstacles such as stationary objects and/or dynamic objects. The one or more environment sensors 122 can be configured to detect, measure, quantify and/or sense other things in the external environment of the vehicle 100, such as, for example, traffic lights, traffic signs, curbs proximate the vehicle 100, off-road objects, sudden elevations and depressions in the path of the vehicle, etc. The example sensors may be part of the one or more environment sensors 122 and/or the one or more vehicle sensors 121.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras, infrared (IR) cameras and so on. In one embodiment, the cameras 126 include one or more cameras disposed within a passenger compartment of the vehicle and/or mounted along an exterior of the vehicle. In one or more arrangements, cameras 126 may be configured to automatically record aspects of the travel route while the vehicle 100 is driving the route. If more than one camera is used, each camera may be oriented in a different direction facing away from the vehicle 100, so that different perspectives of the travel route may be recorded and viewed. The cameras 126 may be configured to record streaming video of the travel route, still photos of the travel route, or both. Streaming video and/or still photos acquired by the cameras 126 may be geotagged as described herein, to associate the camera images with geographical locations of the images.

The vehicle 100 can include an input system 130. An “input system” includes any device, component, system, element or arrangement or groups thereof that enable information/data to be entered into a machine. The input system 130 can receive an input from a vehicle passenger (e.g. a driver or a passenger). In one or more arrangements, the input system 130 may be configured to enable a user to adjust the display parameters of a travel route being traveled and/or reviewed on one or more elements of an output system 135 (described below).

The vehicle 100 can include an output system 135. An “output system” includes any device, component, or arrangement or groups thereof that enable information/data to be presented to a vehicle passenger (e.g. a person, a vehicle passenger, etc.). In one or more embodiments, the output system may include an interactive touchscreen usable for both entry of input commands and output display. Alternatively, an output may be a conventional display screen. The output system may include multiple display screens. In some arrangements, one or more of the display screens may be mounted inside the vehicle interior, while one or more other display screens (for example, a display of a mobile communication device) are separate or detachable from the vehicle. In addition, one of more of the displays may be configured for split screen operation, whereby the display field may be sub-divided into two or more views for showing different aspects of the same travel route and/or aspects of two or more different travel routes.

In one or more examples, functions of the input system 130 and the output system may be combined in the form of an interactive touchscreen and/or keypad enabling the user to specify display parameters of streaming video and/or other information relating to a route currently being traveled or being examined for possible future travel. The user may be enabled to select and/or adjust, for example, the content of the information displayed, the speed of the information displayed, and/or other aspects of the information to be displayed.

The navigation system 147 can include one or more devices, sensors, applications, and/or combinations thereof, now known or later developed, configured to determine the geographic coordinates or location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system. Navigational coordinates determined or received by the navigation system 147, as well as other information, may be geotagged as described herein to video information relating to travel routes, to associate the navigational coordinates with images of the routes. In one or more arrangements, the navigation system 147 can receive and interpret navigational coordinates and/or other information defining an existing and/or previously-driven travel route (for example, a travel route stored in the route directories and files). The navigation system 147 may use this information to aid in autonomously or semi-autonomously guiding the vehicle 100 along the travel route.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving module(s) 198. Any suitable actuator can be used. For instance, the one or more actuators 150 can include motors, pneumatic actuators, hydraulic pistons, relays, solenoids, and/or piezoelectric actuators, just to name a few possibilities.

In one or more embodiments, the travel route observation and comparison system may include one or more of the processors 110. The travel route observation and comparison system 170 is shown as including at least one processor 110 from the vehicle 100 of FIG. 1. Accordingly, the processor 110(s) may be a part of the travel route observation and comparison system 191, the travel route observation and comparison system 191 may include a separate processor from the processor(s) 110 of the vehicle 100, or the route observation and comparison system 191 may access the processor(s) 110 through a data bus or another communication path.

In one or more embodiments, the travel route observation and comparison system 191 may include (or be in operable communication with) a memory 199 communicably coupled to the one or more processor(s) 110. Memory 199 may be a memory of the vehicle. The memory 199 may be a random-access memory (RAM), read-only memory (ROM), a hard-disk drive, a flash memory, or other suitable memory for storing the various modules described herein, including a display control module 197, a correlation module 196, one or more autonomous driving modules 198, and (optionally) other modules (not shown).

The modules described herein can be implemented as computer-readable program code or instructions that, when executed by a processor 110, implement one or more of the various processes described herein. One or more of the modules can be a component of the processor(s) 110, or one or more of the modules can be executed on and/or distributed among other processing systems to which the processor(s) 110 is operably connected. The modules can include instructions (e.g., program logic) executable by one or more processor(s) 110. Alternatively, or in addition, one or more data store 115 may contain such instructions.

Some or all operations of the vehicle 100 may be autonomously controlled, for example, by one or more of the module(s) described herein. As used herein, “autonomous control” refers to controlling various aspects of the movement and/or other operations of the vehicle 100 with minimal or no input from a human operator. In one or more embodiments, operation of the vehicle 100 is highly automated or completely automated.

Generally, “module”, as used herein, includes routines, programs, objects, components, data structures, and so on that perform particular tasks or implement particular data types. In further aspects, a memory 199 generally stores the modules described herein. The memory 199 associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 198. The autonomous driving module(s) 198 can be configured to receive data from the sensor system 120, the travel route observation and comparison system 191, and/or any other type of system capable of capturing information relating to the vehicle 100 and/or the external environment of the vehicle 100. The autonomous driving module(s) 198 can determine position and velocity of the vehicle 100. The autonomous driving module(s) 198 can determine the location of obstacles, or other environmental features including traffic signs, trees, shrubs, neighboring vehicles, pedestrians, terrain features, etc.

The autonomous driving module(s) 198 can be configured to receive, and/or determine location information for obstacles within the external environment of the vehicle 100 for use by the processor(s) 110 and/or one or more of the modules described herein, to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving module(s) 198 either independently or in combination with the travel route observation and comparison system 191 can be configured to determine travel path(s), current autonomous driving maneuvers for the vehicle 100, future autonomous driving maneuvers and/or modifications to current autonomous driving maneuvers based on data acquired by the sensor system 120 and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 198 can be configured can be configured to implement determined driving maneuvers. The autonomous driving module(s) 198 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 198 can be configured to execute various vehicle functions and/or to transmit data to, receive data from, interact with, and/or control the vehicle 100 or one or more systems thereof (e.g. one or more of vehicle systems 140).

Memory 199 may store a display control module 197. Generally, the display control module 197 may include instructions that when executed by the one or more processor(s) 110 cause the one or more processor(s) to control display of one or more vehicle travel routes in accordance with user instructions and/or default instructions to be followed in the absence of user instructions. The display control module 197 may control operation of one or more displays to display information relating to a single travel route or to display information relating to multiple travel routes simultaneously. The information to be displayed may be streamed from a source off-vehicle or from data stores 115. Alternatively, the information to be displayed may be loaded into a buffer included in (or in communication with) the display control module 197 prior to and/or during display of the information. The display control module 197 may be configured to control display of the information as it is received and/or played back to a user, from whatever source.

Display control module 197 may include instructions that when executed by the one or more processor(s) 110 cause the processor(s) to control at least one display device to simultaneously display at least a first visual representation of at least a portion of a first travel route currently being traveled by the vehicle 100 and a second visual representation of the at least a portion of the first travel route during a previous traveling of the first route.

In one or more embodiments, the first visual representation of the at least a portion of the first travel route may be generated using vehicle camera data acquired during the current trip of the vehicle 100 along the travel route, and the second visual representation of the at least a portion of the first travel route may be generated using vehicle camera data acquired during the previous trip along the first travel route, either by the vehicle 100 or by another vehicle.

Generally, a “visual representation” of a travel route is a representation communicated so as to be visually perceivable by a human user (for example, a driver or vehicle occupant). For example, the visual representation may be projected or displayed on some type of display screen (such as a vehicle touch screen or the display screen of a mobile device) or presented on any other visually perceivable medium.

In one aspect, a “visual representation” of at least a portion of a travel route may be a streaming or continuous real-time video of the at least a portion of the route as provided by a vehicle-level camera mounted on the vehicle as the vehicle travels the route. In one or more arrangements, and as described herein, images in a frame (or a currently streaming sequence of a predetermined number of frames) of streaming video currently being displayed may correspond to a current geographical location of the vehicle 100 along the route.

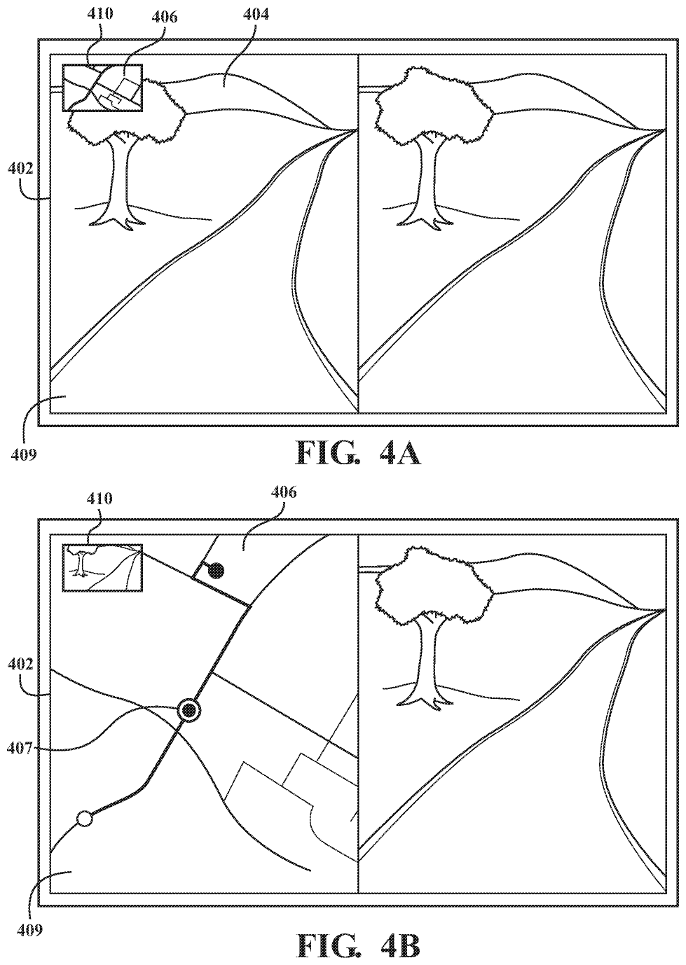

In another aspect, and as shown in FIG. 4B for example, a “visual representation” of at least a portion of a route may be a digital graphical representation or “track” of the portion of the route (or the entire route) shown superimposed or laid over a digital map of a geographical area over which the route extends. As known in the pertinent art, the route track may be displayed in any of a variety of colors selected for contrast with the background digital map onto which the track is overlaid. The display control module 197 may also be configured to, in a known manner, superimpose a digital cursor upon the digital graphical representation of the travel route to indicate a current geographical location of the vehicle 100 along the route. Such digital maps are well-known as maps generated by mobile device map applications based on a destination input by a user.

In yet another aspect, a “visual representation” of at least a portion of a route may also be one or more still photographs of at least a portion of the route taken from a vehicle camera while driving the route. In one or more arrangements, a photograph of a portion of the route taken during a previous traveling of the route and being currently displayed in the vehicle 100 may correspond to a current geographical location of the vehicle along the route.

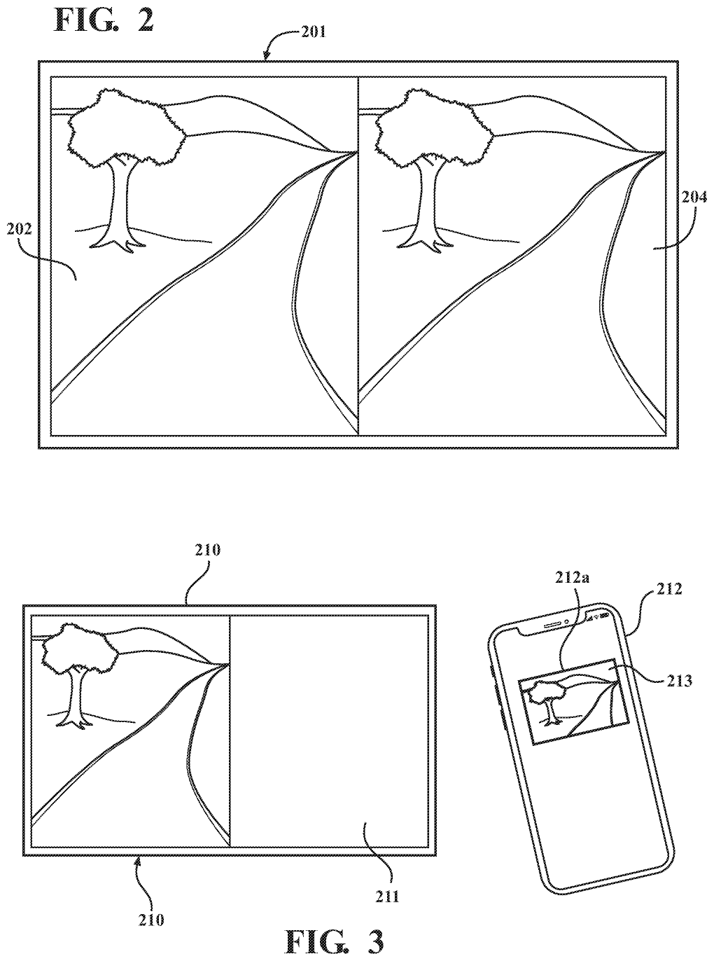

Referring to FIG. 2, in particular embodiments, the first visual representation 202 may be in the form of streaming video of the at least a portion of a first travel route generated from vehicle camera data acquired during a current traveling of the first route by the vehicle 100, and the second visual representation 204 may be in the form of streaming video of the at least a portion of the first travel route generated from camera data acquired by a vehicle-level camera during a previous traveling of the first route. The vehicle which previously traveled the first route may be the same vehicle that is currently traveling the first travel route, or the vehicle which previously traveled the first travel route may be another vehicle. Thus, the vehicle 100 currently traveling the first route may use and display images and other information acquired by other vehicles which have traveled the same route the vehicle 100 is currently traveling. In embodiments described herein, one or more of the visual representations displayed on a display device may be in the form of photographic (streaming or still) images acquired by one or more vehicle-level cameras mounted on a vehicle.

In one or more arrangements, the display control module 197 may control playback of a previously recorded streaming video file of a travel route so that the file is played back without modification, at the same speed at which the video was acquired. Alternatively, the playback speed may be increased by a known factor (for example, 2×, 3×, etc.). The playback speed may be adjusted in this manner by a user through the input system 130.

Referring again to FIG. 2, in one or more arrangements, the display control module 197 may be configured to control a single display device 201 to display the first visual representation 202 and the second visual representation 204 on the single display device 201, in a split screen arrangement.

Referring to FIG. 2A, in particular arrangements, a user may select a display option which shows value(s) of one or more vehicle operating parameters occurring at the geographical location on a first travel route shown on the display, during a previous traveling of the travel route and at the point in time when the image data was acquired. This option enables vehicle sensor data gathered during a previous traveling of a travel route to be displayed and associated with features of the travel route, as conveyed by the camera images. For example, the display in FIG. 2A shows the values of vehicle speed, RPM, throttle position, brake application % and engine coolant temperature at the route location shown on the playback portion of the display at the point in time when the image data shown in the second visual representation was acquired. This information may be continuously and dynamically displayed during playback as the vehicle traverses the route so that a user can see variations in parameter values as the vehicle which previously traveled the route proceeds along the route. This information may be helpful to the user in planning another trip along the route. The information may be displayed in any desired format. FIG. 2A shows the information as an inset within display portion 204a. The user may select the particular parameter values to be displayed.

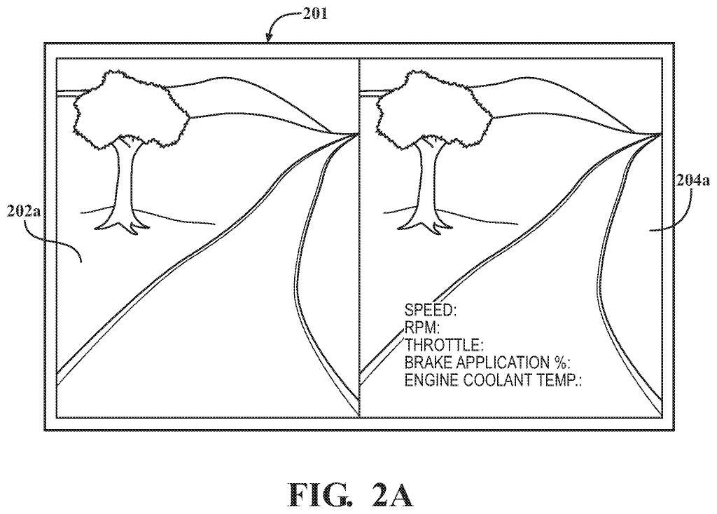

Referring to FIG. 3, in one or more arrangements, the display control module 197 may be configured to control a first display device 210 to display the first visual representation, and to control another display device 212 different from the first display device 209 to display the second visual representation. For example, FIG. 3 shows a first visual representation 211 displayed on a display device 210 in the form of a vehicle touchscreen and a second visual representation 213 displayed on a screen 212a of another display device in the form of a mobile phone 212 of a vehicle occupant.

Referring to FIGS. 4A and 4B, in another aspect, the display control module 197 may be configured to enable a user to toggle a first visual representation 402 between streaming video 404 of the at least a portion of the first travel route at a current geographical location of the vehicle 100 during traveling of the route, and a digital graphical representation 406 of the first route including a cursor 407 superimposed on the digital graphical representation 406 of the first route. In addition, the display control module 197 may be configured to constantly control movement of the digital graphical representation cursor 407 along the digital graphical representation 406 of the first travel route as the vehicle 100 moves along the route, so that the position of the digital graphical representation cursor 407 along the digital graphical representation 406 of the first route indicates a current geographical location of the vehicle 100 on the first route. The views may be toggled by touching or otherwise activating the inset 410 appearing in a corner of the main view 409. The inset 410 may show a smaller version of the alternative view (for example, either a streaming video of the first travel route at the current geographical location of the vehicle 100, or a digital graphical representation 406 of the first route). The digital graphical representation cursor 407 may be configured to blink or to alternately expand and contract to draw the user's attention to the cursor, thereby making the cursor easier to find quickly. Thus, a user may determine a position of the vehicle 100 along the first travel route by viewing the digital graphical representation 406 of the first route and associating this position with the images in the streaming video. FIG. 4A shows a display with a vehicle-level view (for example, from a vehicle camera) in the main view 409 of the first visual representation 402 and a digital graphical representation 406 of the route in the inset 410. In FIG. 4B, after toggling the inset 410 in FIG. 4A, the digital graphical representation 406 of the travel route that was in the inset 410 now appears in the main view 409, while the vehicle-level view 404 formerly in the main view appears in the inset 410.

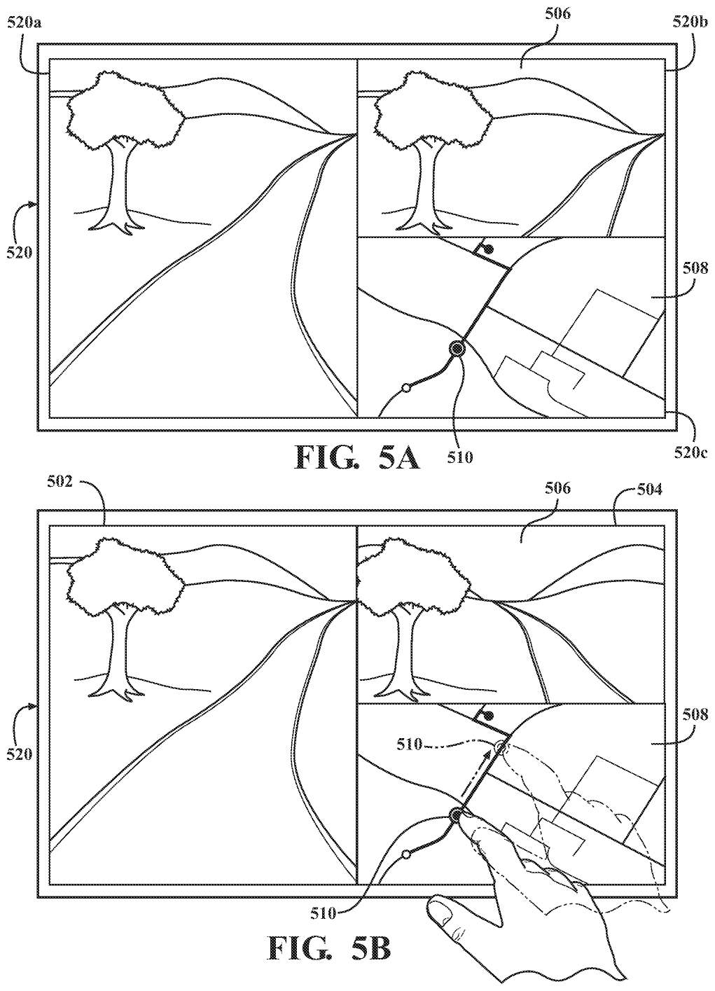

Referring to FIGS. 5A-5B, in one or more arrangements, the display control module 197 may be configured to display the first visual representation in the form of streaming video of the at least a portion of a first travel route generated from vehicle camera data acquired during a current traveling of the first route by the vehicle 100. In addition, the display control module 197 may be configured to enable a user to select simultaneous display of, in the second visual representation, recorded streaming video of the at least a portion of the first route, and a digital graphical representation of the first route including a cursor superimposed on the digital graphical representation of the first route. The second visual representation cursor may be operable to be moved by a user along the digital graphical representation of the first route. The location along the first travel route shown in the second visual representation recorded streaming video may correspond to the position on the digital graphical representation of the first travel route where the second visual representation cursor resides. In embodiments where the display medium is a touch screen, the user may move the second visual representation cursor along the digital graphical route track simply by touching and dragging the cursor across the screen. Alternatively, the second visual representation cursor may be moved along the route track using a keypad, mouse, or other mechanism. Because the displayed image in the second visual representation recorded streaming video always reflects the navigational coordinates of the portion of the route on which the cursor is currently positioned, a user may move the second visual representation cursor ahead of the vehicle 100 current location along the route to “look ahead” on the route. This may enable the user to view upcoming terrain features and other characteristics of the route prior to the vehicle reaching such features.

For example, referring to FIGS. 5A-5B, FIG. 5A shows a display in the form of an interactive touch screen 520 divided into three portions 520a, 520b, 520c by control operations of the display control module 197. Portion 520a may show (in the first visual representation) a camera image reflecting a current geographical location of the vehicle 100 along the route. Portion 520b may show (in part of the second visual representation) camera images 506 of the same route at the same geographical location, according to streaming video recorded during a previous traveling of the route. Portion 520c may show a digital graphical representation 508 of the travel route including a cursor 510 indicating a current location of the vehicle 100 along the route. As shown in FIG. 5B, a user may touch the screen 520 to drag the cursor 510 along the digital graphical representation 508 of the route, to a part of the route yet to be reached by vehicle 100. This may have the effect in display portion 520b of “fast-forwarding” the recorded video playback shown in portion 520b, to a location on the route where the cursor 510 has been moved by the user. The display portion 520b then displays the part of the route corresponding to the geographical location indicated by the current position of the cursor 510, enabling the user to look ahead along the route.

In one or more arrangements, the display control module 197 may be configured to enable control of a display device so as to coordinate display of the second visual representation with a current geographical location of the vehicle so that the second visual representation constantly represents the portion of the first route located at the current geographical location of the vehicle, but during the previous traveling of the first route. Thus, the playback speed of the recorded streaming video may be constantly controlled by the display control module 197 so that the second visual representation (which is a video record of a previous trip along the route) comprises image(s) of the portion of the route residing at the current navigational coordinates of the vehicle currently driving along the route.

During the current traveling of the route by the vehicle 100, the vehicle may travel at the same speed (or may maintain the same speed profile) as a vehicle which recorded the streaming video shown in the second visual representation during the previous traveling of the trail. In such a case, the images of the second visual representation should reflect the portion of the route located at the current navigational coordinates of the vehicle 100, during the entire trip of the vehicle 100 along the travel route. The speed profile of a vehicle during driving of a route may be a record of the vehicle speed(s) at each location on the route during driving of the route, and may indicate changes in speed, rates of change in speed (i.e., accelerations and decelerations), and other vehicle speed-related information as the vehicle drove the route. This information may be geotagged with navigational coordinates as described herein to provide a record of vehicle speed correlated with geographical position of the vehicle at all locations along the route.

In other cases, the vehicle 100 may drive either faster or more slowly than a vehicle which recorded the streaming video during the previous traveling of the route. In such cases, due to the differing speeds of travel, the playback images shown in the second visual representation may not (without modification) represent how the route looks at the current navigational coordinates of the vehicle 100. In such cases, video smoothing algorithm(s) and/or other video processing techniques may be applied to the previously recorded streaming video of the second visual representation to compensate for adjustments to the playback speed needed to bring the navigational coordinates of the geotagged recorded video into correspondence with the actual current navigational coordinates of the vehicle 100.

The display control module 197 may also be configured to enable control of playback of the streaming video of the second visual representation so that playback stops if the vehicle 100 currently driving the route stops along the route. While the vehicle 100 remains stopped, the image of the second visual representation may be in the form of a still image reflecting a camera view of the route and surroundings at the geographical location where the vehicle 100 has stopped.

An additional advantage of an arrangement where the playback speed of the recorded streaming video is constantly controlled by the display control module 197 so that the second visual representation comprises image(s) of the portion of the route residing at the current navigational coordinates of the vehicle may be that a driver or other user will have a camera view of the route (i.e., the view acquired during previous traveling of the route) even if the camera showing the first visual representation of the current trip is not functioning properly.

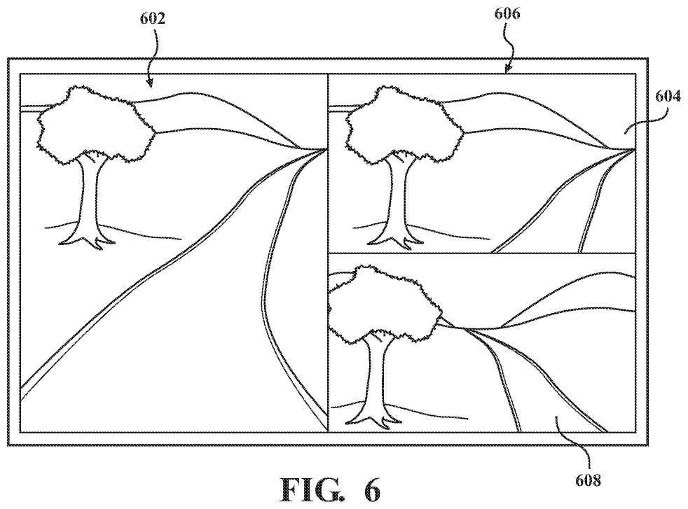

Referring to FIG. 6, in one or more arrangements, the display control module 197 may be configured to enable control of a display device to, simultaneously with displaying the first visual representation and the second visual representation, display a third visual representation representing the at least a portion of the first travel route and generated from data acquired during the previous traveling of the first route. The portion of the first travel route shown in the third visual representation may be a different view of the same portion of the route shown in the second visual representation, from example from a different viewing angle. In one example, the second visual representation may be generated from image data that was acquired by a vehicle first camera, and the third visual representation may be generated from image data that was acquired by a vehicle second camera mounted on the same vehicle and different from the vehicle first camera. The second vehicle camera may be configured to provide a perspective or view different from that provided by the first vehicle camera. Thus, in the example shown in FIG. 6, the first visual representation 602 shows a camera view of the current position of the vehicle 100 on the travel route. A first portion 604 of the second visual representation 606 contains a view of the same route taken during a previous traveling of the route. In addition, a second portion 608 of the second visual representation 606 shows another view of the same route also taken during a previous traveling of the route, but from a different perspective than that of the view shown in the first portion 604 of the second visual representation 606. This may provide a user with a different visual perspective of the route, to help gain a better understanding of the route features.

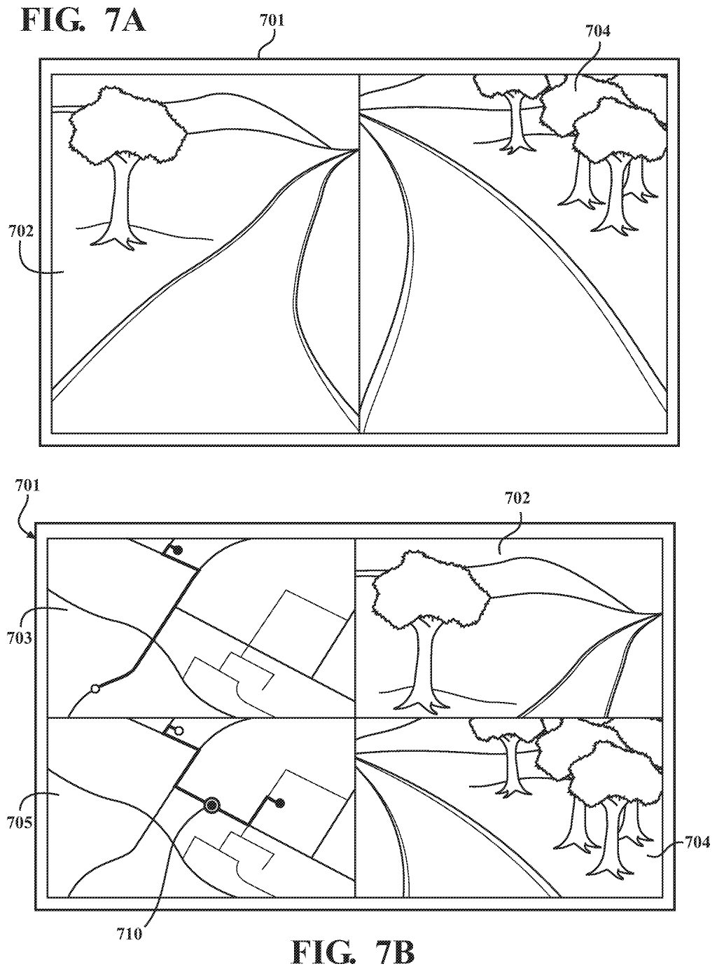

Referring to FIG. 7A, in one or more arrangements, the display control module 197 may be configured to enable control of a display device 701 to simultaneously display at least a first visual representation 702 representing at least a portion of a first travel route currently being traveled by the vehicle 100, and a second visual representation 704 representing at least a portion of a second travel route, where the second travel route is different from the first travel route. This aspect may enable a simultaneous side-by-side visual comparison of two different travel routes. In one or more arrangements, the first visual representation 702 may be in the form of streaming video of the at least a portion of the first travel route generated from data acquired by the vehicle 100 during a current traveling of the first route by the vehicle, and the second visual representation 704 may be in the form of streaming video of the at least a portion of the second travel route. The video of the second route may have been acquired and recorded during a previous traveling of the second route by the vehicle 100 or by a different vehicle.

Referring to FIG. 7B, in one or more particular arrangements, the display control module 197 may be configured to enable control of the display device 701 to display a digital graphical representation 703 of the first travel route adjacent the first visual representation 702 showing streaming video of the at least a portion of the first travel route, and to display a digital graphical representation 705 (including a cursor 710) of the second travel route adjacent the streaming video of the second visual representation 704 of the at least a portion of the second travel route. Playback of the streaming video of the different views of the second travel route may then be controlled in a manner previously described herein, for example, using cursor manipulation to preview the different features and perspectives of the second travel route.

In one or more arrangements, the display control module 197 may be configured to operate in communication with the autonomous driving module(s) 198 to enable the autonomous driving module to control a speed of the vehicle 100 in accordance with a vehicle speed which correlates with image data acquired by a camera of a vehicle during a previous traveling of the travel route, and which also correlates with a geographical location of the previous vehicle along the route at a point in time when the image data was acquired. Stated another way, the autonomous driving module(s) 198 may control operation of the vehicle 100 so as to drive the vehicle 100 along the travel route while following the same speed profile as the vehicle which acquired the streaming video during its previous trip along the route. In this operational mode, the autonomous driving module(s) 198 autonomously drives the vehicle 100 so as to reproduce the speed profile and previous trip of the vehicle which acquired the streaming video, so that the current position of the vehicle 100 along the route always matches the image of the route shown in the streaming video playback to the greatest degree possible.

Referring again to FIG. 1, in one or more arrangements, the travel route observation and comparison system 191 may include (or be in operable communication with) a correlation module 196 including instructions that when executed by the processor(s) 110 cause the processor(s) to correlate or associate data input from each vehicle camera with GPS or other navigational coordinates of the vehicle 100 at the time the camera data is acquired (a process known as “geotagging”). In one or more arrangements, the correlation module 196 may be configured to geotag the camera data with navigational coordinates and, optionally, other information. Geotagging may add geographical identification metadata to various media such as a photographs and video. This metadata may comprise, for example, latitude and longitude and/or other navigational coordinates; altitude, bearing, and/or distance data, place names, a time stamp, and/or other information.

In one or more particular arrangements described herein, image data (i.e., photographs and/or video) acquired by a vehicle camera during traveling of a route may be geotagged with a speed of the vehicle at the location of the vehicle when the image data was acquired. The correlation module 196 may be configured to tag a video file with the desired information as the file image data is acquired. The correlation module 196 may be in communication with any vehicle sensors or other sources of information to be tagged to the streaming video file. If any processing of sensor data may be required prior to tagging of the video file, the correlation module 196 may be configured to process all or part of the data. Alternatively, all or part of the data processing may be performed by other devices (for example, the sensors themselves). The geotagged video file may then be stored in a memory in the vehicle (such as memory 199) or may be uploaded off-vehicle to cloud storage or another destination.

For example, the correlation module 196 may be configured to associate or “tag” a set of navigational coordinates with a frame or a number of frames of a stream of video acquired by each vehicle camera during traveling of the travel route. The correlation module 196 may associate or “tag” frames(s) in the video stream with navigational coordinates of the vehicle 100 corresponding to the vehicle geographical location represented by the frame(s) in the video stream (i.e., the geographical location of the vehicle 100 when the data relating to the frame(s) in the video stream were acquired). In one or more arrangements, this may be done for points in the video stream at predetermined distance intervals (for example, every 50 feet) along the route traveled by the vehicle 100. The frequency of “tagging” or association may depend on the resolution and error of the GPS system in determining the vehicle coordinates and other factors. These associations may be performed continuously while the vehicle 100 is traveling a route, so that camera images acquired during traveling the route are associated with geographical locations corresponding with the camera images, for playback purposes. By this method, a still camera image or a portion of a video stream may be associated with the geographical location of the vehicle 100 when the image or the portion of the stream was acquired by the camera. Consequently, in one or more embodiments, the display control module 197 may be configured to control operation of a display medium to display or play back files which have been geotagged by a correlation module 196 as described herein.

Camera image data may be geotagged with navigational information and/or vehicle operational information as the information is gathered. Alternatively, the tagging and mutual association of the various types of data may be performed after data acquisition and offline, using time stamps and/or other methods to correlate the data. In particular arrangements, the correlation module 196 may include instructions that when executed by the processor(s) 110 cause the processor(s) to geotag data input from each vehicle camera with various sensor data describing vehicle operational parameters at the time the camera data is acquired, as well as with the vehicle GPS/navigational coordinates of the vehicle 100 at the time the camera data is acquired. The geotagging may correlate the vehicle operational data, geographical identification metadata and the various media such as a photographs and video, so that values of vehicle operating parameters at any location along a traveled route may be recorded for later review and analysis.

In another aspect of the embodiments described herein, a computer-implemented method is provided for controlling a display device to display images representing at least a first route which is currently being traveled by a vehicle. The method may include steps of, by a processor(s), displaying a first visual representation representing at least a portion of the at least a first route, and simultaneously displaying, by the processor(s), a second visual representation representing the at least a portion of the at least a first route during a previous traveling of the first route. The method may further include the step of controlling, by the processor(s), the at least one display device so as to coordinate display of the second visual representation with a current geographical location of the vehicle so that the second visual representation represents the at least a portion of the first route at the current geographical location of the vehicle.

The method may further include the step of enabling, by the processor(s), a user to toggle the first visual representation between streaming video of the at least a portion of the first route at a current geographical location of the vehicle during traveling of the route, and a digital graphical representation of the first route including a cursor superimposed on the digital graphical representation of the first route. Movement of the first visual representation cursor along the digital graphical representation of the first route may be constantly controlled by the processor(s) so that the position of the first visual representation cursor along the digital graphical representation of the first route indicates a current geographical location of the vehicle on the first route. The method may further include the step of, by the processor(s) enabling a user to toggle the second visual representation between streaming video of the at least a portion of the first route at a current geographical location of the vehicle during traveling of the route, and a digital graphical representation of the first route including a cursor superimposed on the digital graphical representation of the first route. The second visual representation cursor may be operable by the processor(s) to be moved by a user along the digital graphical representation of the first route, and the location along the first travel route represented by the second visual representation streaming video may correspond to the position on the digital graphical representation of the first travel route where the second visual representation cursor resides.

Thus, as described herein, the display control module 197 may be configured to control display of camera images of portions of a driving route currently being driven by the vehicle 100. The display control module 197 may be configured to receive and/or operate on tagged streaming video files and still image files, to control display of the video and still image files according to user preferences or default instructions. The display control module 197 may be configured to extract navigational coordinates, velocity information, and any other information with which the video files and still image files have been tagged. Such “tagged” information may be used to aid in controlling image display and other operations of the vehicle 100, including autonomous driving by the autonomous driving module(s) 198.

Using the input system 130, a user may select the informational content and mode of display in accordance with any of the embodiments described herein, assuming that the display control module 197 is configured to control information display in the manner desired and that the information required for display using the desired mode (for example, a vehicle second camera view of a travel route) is available. During information display, the presentation of information may be controlled in accordance with any of the options described herein, to enable the user to view different locations along a travel route, to view the route from different perspectives, and/or to compare the route currently being traveled with one or more other travel routes.

The processor(s) 110, the display control module 197, and/or the autonomous driving module(s) 198 can be operably connected to communicate with each other and with the various vehicle systems 140 and/or individual components thereof. The processor(s) 110, the display control module 197, and/or the autonomous driving module(s) 198 may be operable to control the navigation and/or maneuvering of the vehicle 100 by controlling one or more of the vehicle systems 140 and/or components thereof. For instance, when operating in an autonomous mode, the processor(s) 110, the display control module 197, and/or the autonomous driving module(s) 198 can control the direction and/or speed of the vehicle 100. The processor(s) 110, the display control module 197, and/or the autonomous driving module(s) 198 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A travel route observation and comparison system for a vehicle, the system comprising one or more processors and a memory communicably coupled to the one or more processors and storing a display control module including instructions that when executed by the one or more processors cause the one or more processors to control at least one display device to simultaneously display at least a first visual representation of at least a portion of a first travel route currently being traveled by the vehicle, and a second visual representation of the at least a portion of the first travel route during a previous traveling of the first travel route.

2. The travel route observation and comparison system of claim 1 wherein the display control module includes instructions that when executed by the one or more processors cause the one or more processors to control the at least one display device to display the at least the first visual representation and the second visual representation on a single display device, in a split screen arrangement.

3. The travel route observation and comparison system of claim 2 wherein the display of the second visual representation includes a value of at least one operating parameter of a vehicle which previously traveled the first travel route, the value having occurred at the a geographical location of the vehicle at a point in time when image data displayed in the second visual representation was acquired.

4. The travel route observation and comparison system of claim 1 wherein the display control module includes instructions that when executed by the one or more processors cause the one or more processors to control the at least one display device to display the at least the first visual representation, and to control another display device different from the at least one display device to display the second visual representation.

5. The travel route observation and comparison system of claim 1 wherein the memory stores a correlation module including instructions that when executed by the one or more processors cause the one or more processors to correlate image data acquired by a camera of the vehicle during traveling of the first travel route, with a geographical location of the vehicle along the first travel route at a point in time when the image data was acquired.

6. The travel route observation and comparison system of claim 1 wherein the first visual representation comprises streaming video of the at least a portion of the first travel route generated from vehicle camera data acquired during a current traveling of the first travel route by the vehicle, and the second visual representation comprises a recorded streaming video of the at least a portion of the first travel route generated from camera data acquired by a vehicle during a previous traveling of the first travel route.

7. The travel route observation and comparison system of claim 6 wherein the display control module includes instructions that when executed by the one or more processors cause the one or more processors to enable a user to toggle the first visual representation between streaming video of the at least a portion of the first travel route at a current geographical location of the vehicle during traveling of the first travel route, and a digital graphical representation of the first travel route including a cursor superimposed on the digital graphical representation of the first travel route, and wherein the display control module includes instructions that when executed by the one or more processors cause the one or more processors to constantly control movement of the cursor along the digital graphical representation of the first travel route so that a position of the first visual representation cursor along the digital graphical representation of the first travel route indicates a current geographical location of the vehicle on the first travel route.

8. The travel route observation and comparison system of claim 6 wherein the display control module includes instructions that when executed by the one or more processors cause the one or more processors to enable a user to control operation of the at least one display to simultaneously display, in the second visual representation, recorded streaming video of the at least a portion of the first travel route, and a digital graphical representation of the first travel route including a cursor superimposed on the digital graphical representation of the first travel route, the second visual representation cursor being operable to be moved by a user along the digital graphical representation of the first travel route, and wherein a location along the first travel route shown in the second visual representation recorded streaming video corresponds to a position on the digital graphical representation of the first travel route where the second visual representation cursor resides.

9. The travel route observation and comparison system of claim 1 wherein the display control module includes instructions that when executed by the one or more processors cause the one or more processors to control the at least one display device so as to coordinate display of the second visual representation with a current geographical location of the vehicle so that the second visual representation represents the at least a portion of the first travel route at the current geographical location of the vehicle.

10. The travel route observation and comparison system of claim 1 wherein the display control module further includes instructions that when executed by the one or more processors cause the one or more processors to control the at least one display device to, simultaneously with displaying the first visual representation and the second visual representation, display a third visual representation representing the at least a portion of the first travel route and generated from data acquired during the previous traveling of the first travel route.

11. The travel route observation and comparison system of claim 10 wherein the second visual representation is generated from image data that was acquired by a vehicle first camera, and the third visual representation is generated from image data that was acquired by a vehicle second camera mounted on the same vehicle as the vehicle first camera and different from the vehicle first camera.

12. The travel route observation and comparison system of claim 1 wherein the display control module includes instructions that when executed by the one or more processors cause the one or more processors to control the at least one display device to simultaneously display at least a first visual representation representing at least a portion of a first travel route currently being traveled by the vehicle, and a second visual representation representing at least a portion of a second travel route, wherein the second travel route is different from the first travel route.

13. The travel route observation and comparison system of claim 12 wherein the first visual representation comprises streaming video of the at least a portion of the first travel route generated from data acquired by the vehicle during a current traveling of the first travel route by the vehicle, and the second visual representation comprises recorded streaming video of the at least a portion of the second travel route.

14. The travel route observation and comparison system of claim 13 wherein the display control module further includes instructions that when executed by the one or more processors cause the one or more processors to control the at least one display device to:
display a digital graphical representation of the first travel route adjacent the streaming video of the at least a portion of the first travel route; and
display a digital graphical representation of the second travel route adjacent the recorded streaming video of the at least a portion of the second travel route.

15. A vehicle including a travel route observation and comparison system in accordance with claim 1.

16. The vehicle of claim 15 further including an autonomous driving module in operable communication with the travel route observation and comparison system and including instructions that when executed by the one or more processors cause the one or more processors to control a speed of the vehicle in accordance with a vehicle speed which correlates with image data acquired by a camera of a vehicle during a previous traveling of the first travel route, and also with a geographical location of the vehicle along the first travel route at a point in time when the image data was acquired.

17. A computer-implemented method of controlling at least one display device to display images representing at least a first travel route which is currently being traveled by a vehicle, the method comprising steps of:
displaying, by a processor, a first visual representation representing at least a portion of the at least a first travel route; and
simultaneously displaying, by the processor, a second visual representation representing the at least a portion of the at least a first travel route during a previous traveling of the first travel route.

18. The computer-implemented method of claim 17 further comprising the step of controlling, by the processor, the at least one display device so as to coordinate display of the second visual representation with a current geographical location of the vehicle so that the second visual representation represents the at least a portion of the first travel route at the current geographical location of the vehicle.

19. The computer-implemented method of claim 17 further comprising the step of, by the processor, enabling a user to toggle the first visual representation between streaming video of the at least a portion of the first travel route at a current geographical location of the vehicle during traveling of the travel route, and a digital graphical representation of the first travel route including a cursor superimposed on the digital graphical representation of the first travel route, wherein movement of the first visual representation cursor along the digital graphical representation of the first travel route is constantly controlled by the processor so that a position of the first visual representation cursor along the digital graphical representation of the first travel route indicates a current geographical location of the vehicle on the first travel route.

20. The computer-implemented method of claim 19 further comprising the step of enabling, by the processor, a user to toggle the second visual representation between streaming video of the at least a portion of the first travel route at a current geographical location of the vehicle during traveling of the first travel route, and a digital graphical representation of the first travel route including a cursor superimposed on the digital graphical representation of the first travel route, wherein the second visual representation cursor is operable, by the processor, to be moved by a user along the digital graphical representation of the first travel route, and wherein a location along the first travel route represented by the second visual representation streaming video corresponds to a position on the digital graphical representation of the first travel route where the second visual representation cursor resides.
